(19) United States
(12) Patent Application Publication
(10) Pub. No.: US 2012/0113971 A1
(43) Pub. Date: May 10, 2012

(54) EFFICIENT WLAN DISCOVERY AND ASSOCIATION

(75) Inventors: Gerardo Giaretta, San Diego, CA (US); Gavin Bernard Horn, La Jolla, CA (US); Arnaud Meylan, San Diego, CA (US)

(73) Assignee: QUALCOMM Incorporated, San Diego, CA (US)

(21) Appl. No.: 13/290,920

(22) Filed: Nov. 7, 2011

Related U.S. Application Data
(60) Provisional application No. 61/411,306, filed on Nov. 8, 2010.

(51) Int. Cl. H04W 84/02; H04W 76/00; H04W 88/08

(52) U.S. Cl. 370/338

(57) ABSTRACT

Methods, systems, and devices are described for discovering and associating with WLAN using Request to Send (RTS) and Clear to Send (CTS) frames. A mobile device may identify a WLAN access point associated with a location of the mobile device. The mobile device may transmit a Request to Send (RTS) frame to the access point and receive a CTS frame from the access point. The mobile device may determine that the access point is within range of the mobile device based on the received CTS frame. Some embodiments may provide for transmitting an association request frame to the access point in response to the received CTS frame. The association request frame may be transmitted to the access point in a time period associated with the CTS frame.

### CROSS REFERENCES

The present application for patent claims priority benefit of U.S. Patent Application No. 61/411,306, entitled “EFFICIENT WLAN DISCOVERY AND ASSOCIATION” by Giaretta et al., having Attorney Docket No. 103324P1, filed Nov. 8, 2010, assigned to the assignee hereof, and expressly incorporated by reference herein.

### BACKGROUND

Many mobile devices are capable of connecting to Wireless Local Area Network (WLAN) access points to transmit and receive data. Before connecting to a WLAN, a mobile device typically conducts a search to discover access points within the range of the mobile device. Conventional methods for discovering WLAN access points, as defined in the Institute of Electrical and Electronics Engineers (IEEE) 802.11 wireless communications standard, include passive scanning, also known as beacon scanning, and active scanning, also known as probe scanning.

In passive or beacon scanning, a mobile device may dwell on each wireless channel and wait to receive a beacon frame from an access point. The mobile device may dwell on each channel for a time between a minimum and maximum limit. In active or probe scanning, the terminal may send a single probe request frame (e.g., on a given channel) and wait for a response from access points (e.g., a beacon frame or probe response frame).

In a typical access point discovery process using beacon or probe scanning, the mobile device may spend a good portion of its discovery time transmitting to or listening for responses from APs that either are nonexistent or do not ultimately establish a connection with the mobile device. Because the radio resources used to transmit and receive wireless communications can consume a significant amount of power, searching for a WLAN access point using these conventional methods may be power inefficient and noticeably shorten the usable battery life of the terminal.

### SUMMARY

Embodiments include methods, systems, and devices for discovering and associating with WLAN access points using Request to Send (RTS) and Clear to Send (CTS) frames. In general, a mobile device may be aware of one or more access points that are associated with a current location of the mobile device. To discover one of these access points, the mobile device may transmit an RTS frame to the access point. If the access point receives the RTS frame from the mobile device, the access point may respond to the RTS frame by transmitting a CTS frame to the mobile device. The mobile device need not be associated with the access point to transmit the RTS frame to the access point or receive the CTS frame from the access point. Consequently, the mobile device may determine whether the access point is within range of the mobile device based on whether a CTS frame is received from the access point in response to the transmitted RTS frame.

Some embodiments may include a method of wireless communication in a mobile device. The method may include identifying a WLAN access point associated with a location of the mobile device. A RTS frame may be transmitted to the access point, and a CTS frame may be received from the access point. The mobile device may determine that the access point is within range of the mobile device based on the received CTS frame.

In some embodiments, the mobile device may transmit an association request frame to the access point in response to the received CTS frame. The association request frame may be transmitted to the access point in a time period associated with the CTS frame. The RTS frame may include a request for clearance to transmit data for a null amount of time. Additionally or alternatively, the RTS frame may include a request for clearance to transmit data for an amount of time that is greater than a threshold associated with receiving a response from the access point.

In some embodiments, the method may include determining the location of the mobile device and determining a set of one or more wireless, including the identified access point and associated with the location of the mobile device. The RTS frame may be automatically transmitted to the set of one or more wireless access points in response to the determination of the location of the mobile device and the determination of the set of one or more wireless access points.

In some embodiments, the method may include determining the location of the mobile device and selectively enabling WLAN connectivity in the mobile device in response to the determination of the location of the mobile device. The determination of the location of the mobile device may include determining that the location of the mobile device is near a location of the access point, and the WLAN connectivity may be selectively enabled in response to the determination of the location of the mobile device and the determination that the location of the mobile device is near the location of the access point.

In some embodiments, the method may include determining that a condition for disabling RTS/CTS discovery has been met and disabling the use of received CTS frames by the mobile device to determine whether access points are in the range of the mobile device. The determination that the condition for disabling RTS/CTS discovery has been met may include determining that no known access point is associated with the location of the mobile device. Probe discovery or beacon discovery may be enabled in the mobile device in response to the determination that the condition for disabling RTS/CTS discovery has been met.

In some embodiments, the method may include communicating with a cellular network to identify the WLAN access point associated with the location of the mobile device. In additional or alternative embodiments, the mobile device may access a table of WLAN access points stored by the mobile device to identify the WLAN access point based on the location of the mobile device.

In some embodiments, the method may include transmitting multiple RTS frames to multiple access points, receiving multiple CTS frames in response to the RTS frames, and determining that a number of the access points are in range of the mobile device based on the received CTS frames. The method may further include selecting one of the access points in range of the mobile device for association with the mobile device. The selection of the one of the access points may be based on a set of rules and/or on input from a user of the mobile device.

Some embodiments include a mobile device configured for wireless communication. The mobile device may include: an access point identification module configured to identify a WLAN access point associated with a location of the mobile device, a transmitter module configured to transmit an RTS frame to the access point, a receiver module configured to determine that the access point is within range of the mobile device based on the received CTS frame.

Some embodiments include an apparatus configured to connect to a WLAN. The apparatus may include: means for identifying a WLAN access point associated with a location of the mobile device, means for transmitting an RTS frame to the access point, means for receiving a CTS frame from the access point, and means for determining that the access point is within range of the mobile device based on the received CTS frame.

Some embodiments may include a computer program product configured to connect to a WLAN that includes a non-transitory computer-readable medium. The non-transitory computer-readable medium may include code: code to identify a WLAN access point associated with a location of the mobile device, code to transmit an RTS frame to the access point, code to receive a CTS frame from the access point, and code to determine that the access point is within range of the mobile device based on the received CTS frame.

Some embodiments may include a method for wireless communication in a WLAN access point. The method may include: receiving an RTS frame at an access point from a mobile device, transmitting a CTS frame from the access point to the mobile device in response to the RTS frame, and receiving an association request frame from the mobile device based on the CTS frame.

In some embodiments, the method for wireless communication in a WLAN access point may include receiving the association request frame from the mobile device within a time period associated with the CTS frame. The time period associated with the CTS frame may include a time period for transmission specified by the CTS frame.

The method for wireless communication in a WLAN access point may further include transmitting an association response frame to the mobile device within the time period associated with the CTS frame. In some embodiments, the RTS frame may include a request for clearance to transmit data to the access point for a null amount of time. Additionally or alternatively, the RTS frame may include a request for clearance to transmit data to the access point for an amount of time that is greater than a threshold associated with receiving a response from the access point.

In some embodiments, the method for wireless communication in a WLAN access point may also include providing a location of the access point to the mobile device. This location may be provided to the mobile device by communicating with a cellular network.

Some embodiments include a WLAN access point apparatus. The WLAN access point apparatus may include: means for receiving a RTS frame at an access point from a mobile device, means for transmitting a CTS frame from the access point to the mobile device in response to the RTS frame, and means for receiving an association request frame from the mobile device based on the CTS frame.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of a wireless communications system;

FIG. 2 shows a block diagram of exemplary sequence of messages exchanged between a mobile device and an access point during WLAN discovery;

FIG. 3A, FIG. 3B, FIG. 3C, and FIG. 3D show diagrams of different stages in an exemplary process of WLAN discovery and association;

FIG. 4 shows a block diagram of an example of a mobile device configured for wireless communication;

FIG. 5 shows a block diagram of another example of a mobile device configured for wireless communication;

FIG. 6 shows a block diagram of an example of an access point configured for wireless communication;

FIG. 7 shows a flowchart of an exemplary method of WLAN discovery at a mobile device;

FIG. 8 shows a flowchart of another exemplary method for WLAN discovery at a mobile device;

FIG. 9 shows a flowchart of another exemplary method for WLAN discovery at a mobile device;

FIG. 10 shows a flowchart of another exemplary method for WLAN discovery at a mobile device;

FIG. 11 shows a flowchart of another exemplary method for WLAN discovery at a mobile device;

FIG. 12 shows a flowchart of an exemplary method for WLAN association at an access point; and

FIG. 13 shows a flowchart of another exemplary method for WLAN association at an access point.

### DETAILED DESCRIPTION OF THE INVENTION

Embodiments include methods, systems, and devices for WLAN access point discovery and association. In these methods, systems, and devices, a mobile device may identify one or more WLAN access points that are associated with a location of the mobile device. The mobile device may identify the one or more access points using access point information stored by the mobile device and/or access point information dynamically provided to the mobile device over a network. To discover if one of these access points exists and is within range of the mobile device, the mobile device may transmit a Request to Send (RTS) frame to the access point using an address or identifier known to the mobile device. The mobile device may determine that the access point exists and is within range of the mobile device if a Clear to Send (CTS) frame is received from the access point in response to the transmitted RTS frame.

In certain embodiments, the mobile device may attempt to associate with the discovered access point using an association request frame. The association request frame may be transmitted to the access point within a time period specified by the CTS frame. In certain embodiments, the access point may respond to the association request frame with an association response frame within the time period specified by the CTS frame.

Techniques described herein may be used for various wireless communications system. For purposes of example, the description below describes a WLAN system based on the Institute of Electrical and Electronic Engineers (IEEE) 802.11 (Wi-Fi) standard. However, the techniques of the present disclosure are applicable beyond Wi-Fi systems.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

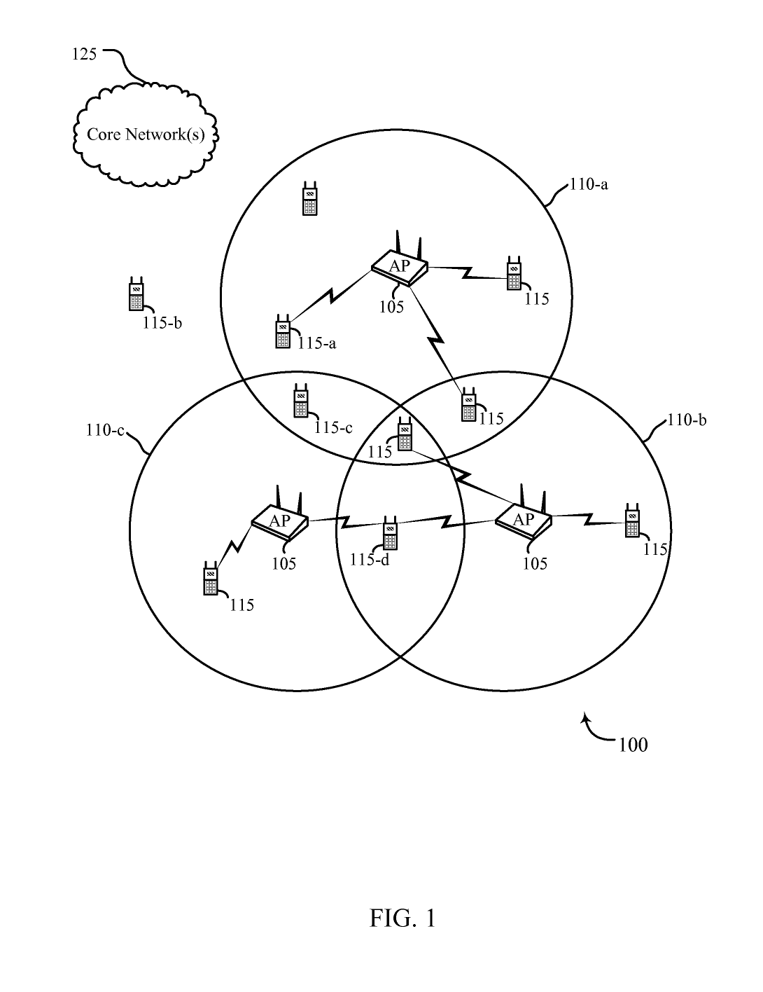

Referring first to FIG. 1, a block diagram illustrates an example of a wireless communications system 100. The system 100 includes access points 105 and mobile devices 115. The system 100 may support operation on multiple carriers (waveform signals of different frequencies).

The access points 105 may be wireless local area network (WLAN) access points that allow the mobile devices 115 to wirelessly access one or more core networks 125. In certain examples, multiple access points 105 may provide access to the same core network 125. Additionally or alternatively, different access points 105 may provide access to different core networks 125.

Each of the access points 105 may wirelessly communicate with the mobile devices 115 via radio signals modulated with data. For example, the access points 105 may communicate with the mobile devices 115 using a version of the IEEE 802.11 standards maintained by the Institute of Electrical and Electronics Engineers, and/or another standard related to Wireless Local Area Networks. Each of the access point 105 sites may provide communication coverage for a respective geographic area. The coverage area for each access point 105 here is identified as 110-a, 110-b, or 110-c.

Generally speaking, when a mobile device 115 is within the coverage area 110 for an access point 105, the access point 105 may be considered to be within range of the mobile device 115. For purposes of the present disclosure, an access point 105 is within range of a mobile device 115 is the mobile device is able to associate with the access point 105. For the purposes of the present disclosure, association occurs when the mobile device 115 registers with the access point 105 and gains access to a core network 125 of the access point 105.

While the coverage areas 110 of FIG. 1 are shown to be substantially uniform for the purpose of clarity, it will be understood that the size of a coverage area 110 for an access point 105 may vary based on a number of factors, including the transmission power of the access point 105, the size and type of antenna(s) associated with the access point 105, the geographical characteristics of the location of the access point 105, and other factors. In certain examples, the coverage areas for different access points 105 may overlap. It should be further understood that while the sizes and shapes of the coverage areas 110 are generalized for all mobile devices 115 in FIG. 1 for the sake of clarity, these sizes and shapes may vary between different mobile devices 115.

The mobile devices 115 may be dispersed throughout the coverage areas 110. The mobile devices 115 may be referred to as mobile stations, mobile devices, access terminals (ATs), user equipments (UEs), subscriber stations (SSs), or subscriber units. The mobile devices 115 may include cellular phones and wireless communications devices, but may also include personal digital assistants (PDAs), other handheld devices, netbooks, notebook computers, tablets, etc.

Each mobile device 115 may be capable of associating with one or more access points 105 within range of the mobile device 115. For example, mobile device 115-a may be within the coverage area 110-a of a single access point 105 and associate with that access point. However, a mobile device 115 may not always be associated with an access point 105. As shown in FIG. 1, mobile device 115-b may be outside of the coverage areas 110 for all access points 105, and therefore be unable to connect to associate with any access point 105. As further shown in FIG. 1, mobile device 115-c may be within the coverage area 110 for one or more access points 105 and not associate with any of the access points 105. In additional examples, a mobile device 115-d may be within the coverage areas 110 for multiple access points 105 and associate with two or more access points 105 simultaneously.

As shown in FIG. 1, different access points 105 may be available to a mobile device 115 at different locations within the system 100. When a mobile device 115 is ready to associate with a new access point 105, the mobile device 115 may perform a discovery process to determine which access points 105 are within range of the mobile device 115. As will be described in more detail below, the mobile devices 115 of the present example may repurpose the Request to Send/Clear to Send (RTS/CTS) protocol of the IEEE 802.11 standard to discover and associate with access points within its range.

For example, the mobile device 115 may be aware of one or more access points 105 that are associated with a current location of the mobile device 115. To discover one of these access points 105, the mobile device 115 may transmit a Request to send (RTS) frame to the access point 105. If the access point 105 receives the RTS frame from the mobile device 115, the access point 105 may respond to the RTS frame by transmitting a CTS frame to the mobile device. The mobile device 115 need not be associated with the access point 105 to transmit the RTS frame to the access point or receive the CTS frame from the access point 105. Consequently, the mobile device 115 may determine whether the access point 105 is within range of the mobile device 115 based on whether a CTS frame is received from the access point 105 in response to the transmitted RTS frame

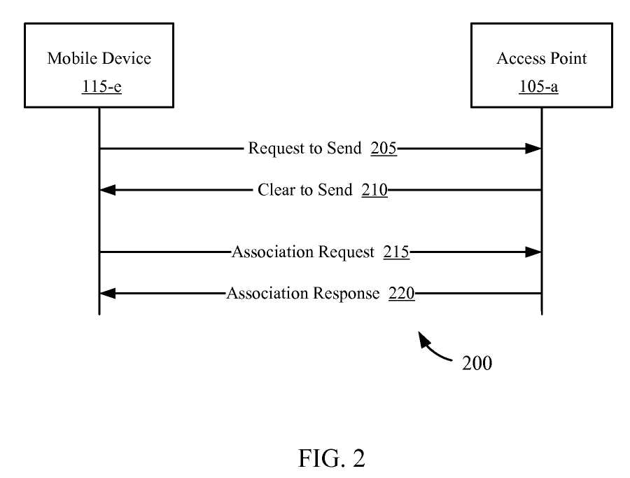

Referring next to FIG. 2, an example is shown of a communications exchange 200 between a mobile device 115-e and an access point 105-a to associate the mobile device 115-a with the access point 115-e. The mobile device 115-e and the access point 105-a may be examples of the mobile device 115 and the access point 105 described above with reference to FIG. 1, respectively.

The mobile device 115-e may use the RTS/CTS protocol defined by the IEEE 802.11 (Wi-Fi) wireless communication standard, or a substantially similar protocol, to discover and associate with the access point 105-a. The RTS/CTS protocol is a handshaking mechanism conventionally used to control access to wireless media and reduce interference from hidden nodes in data transmissions. In one example of hidden node interference, a data transmission from a first station to a second station encounters interference from a third station undetected by the first station.

Under conventional uses of the RTS/CTS protocol, a mobile device (e.g., mobile device 115 of FIG. 1 or 2) desiring to transmit data to an access point (e.g., access point 105 of FIG. 1 or 2) may send an RTS frame to the access point specifying a duration of time for which access to the wireless medium is requested. A typical RTS frame is little more than a simple Media Access Control (MAC) header with a duration field that specifies the requested duration of time. The access point responds with a CTS frame indicating that the mobile device is clear to transmit to the access point for a specified amount of time. Like the RTS frame, the CTS frame may MAC header with a duration field which specifies the amount of time for which the mobile device is clear to transmit data to the access point. All other network devices connected to the access point may also receive the CTS frame, and silence data transmissions for the specified amount of time, thereby reducing or eliminating interference to the data transmitted by the mobile device.

In addition to this intended purpose of the RTS/CTS protocol, the mobile device 115-a may repurpose the RTS/CTS protocol to discover and associate with access point 105-a. This is possible due to the fact that the mobile device 115-e need not be associated with the access point 105-a to engage the access point 105-a in an RTS/CTS handshake. Put differently, the RTS/CTS protocol allows for any mobile device 115-e to communicate with the access point, regardless of whether the access point 105-a was previously aware of the mobile device 115-e.

Thus, to discover the access point 105-a, the mobile device 115-e may first determine that the access point 105-a is associated with a current location of the mobile device 115-e. This determination may occur in a number of ways. For example, the mobile device 115-e may access a table of access points stored by or accessible to the mobile device 115-e to identify the access point 105-a based on the current location of the mobile device 115-e. The table may associate location information with identifiers of access points (e.g., Media Access Control (MAC) addresses, Service Set Identifiers (SSIDs), Basic Service Set Identifiers (BSSIDs) etc.).

The information in the table may include information stored by the mobile device 115-e based on previous interactions with the access point 105-e. Additionally or alternatively, the table may include information from other users or devices that associates access point 105-a identifiers with the location information. In still other examples, the mobile device 115-e may dynamically retrieve or receive information associating the access point 105-a with the current location of the mobile device 115-e from an active connection to a different network device, such as another access point or a base station for a cellular network. For instance, a cellular network may provide a message to the mobile device 115-e with a list of available access points 105 when the mobile device 115-e enters a given location.

Once the mobile device 115-e has determined that the access point 105-a is associated with the current location of the mobile device 115-e, the mobile device 115-e may determine whether the access point 105-e is within range of the mobile device 115-e. To make this determination, the mobile device 115-e may transmit an RTS frame 205 to the access point 105-a. The RTS frame 205 may be transmitted to a MAC address, SSID, or BSSID for the access point 105-a. The RTS frame 205 may request clearance to transmit during a null amount of time or an amount of time greater than a threshold associated with receiving a response from the access point 105-a.

If access point 105-a receives the RTS frame 205 from the mobile device 115-e, the access point 105-a may transmit a CTS frame 210 to the mobile device in response. The time for responding to an RTS frame 205 is typically short and fixed. Thus, the mobile device 115-e may determine in a relatively short amount of time whether the access point 105-a is within range of the mobile device 115-e based on whether a CTS frame 210 is received within the designated time for response.

If the CTS frame 210 is received by the mobile device 115-e, the mobile device 115-e may determine that the access point 105-a is within range of the mobile device 115-e and transmit an association request frame 215 to the access point 105-a. In certain examples, the mobile device 115-e may transmit the association request frame 215 to the access point 105-a within the amount of time specified by the CTS frame 210. As described above, the amount of time specified by the CTS frame 210 may specify the amount of time for which the mobile device 115-e is cleared to transmit to the access point 105-a. The amount of time specified by the RTS frame 205 may or may not be related to the amount of time specified in the RTS frame 205.

By transmitting the association request frame 215 to the access point 105-a during the amount of time specified by the CTS frame 210, there is an added benefit of silence from other nodes in communication with the access point 105-a while the association request frame 215 is transmitted. In this way, the association request frame 215 may be received at the access point 105-a with minimal interference from other nodes.

The access point 105-a may transmit an association response frame 220 in reply to the association request frame 215 from the mobile device 115-e. If the mobile device 115-e meets the criteria for joining the core network associated with the access point 105-a, association response frame 220 may confirm that the mobile device 115-e is now associated (i.e., registered with access to the core network) with the access point 105-a. Otherwise, the association response frame 220 may indicate that the mobile device 115-e has not been associated with the access point 105-a.

The use of RTS/CTS protocol to discover whether an access point 105-a may augment conventional WLAN access point discovery methods in the mobile device 115-e, such as beacon discovery and probe discovery. Because the amount of time to discover access point 105-a using RTS/CTS protocol may be shorter than the amount of time needed to discover the access point 105-a using beacon or probe discovery, in certain examples it can be more power efficient for the mobile device 115-e to discover access point 105-a using the RTS/CTS protocol than with beacon or probe discovery. This boost in power efficiency may translate to an increase in battery life for mobile device 115-e.

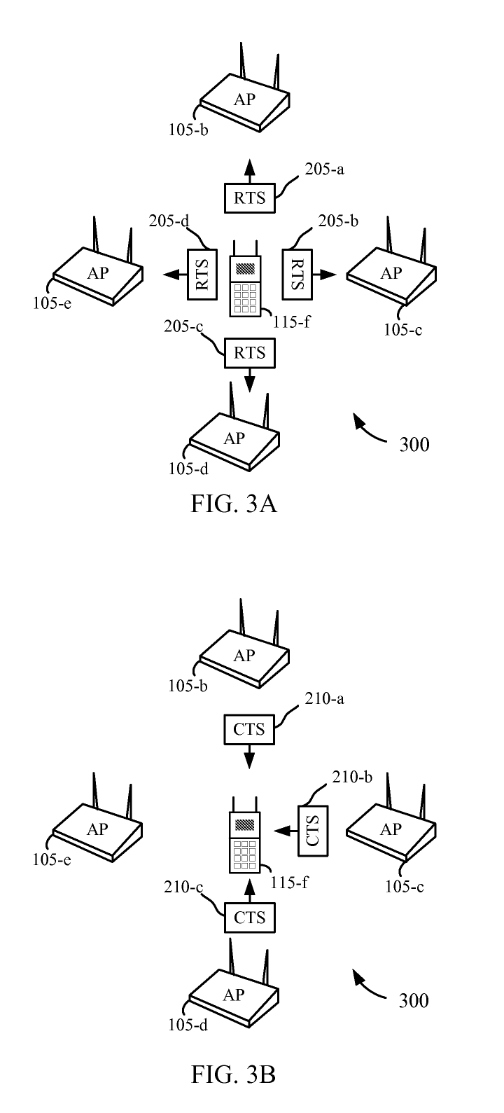

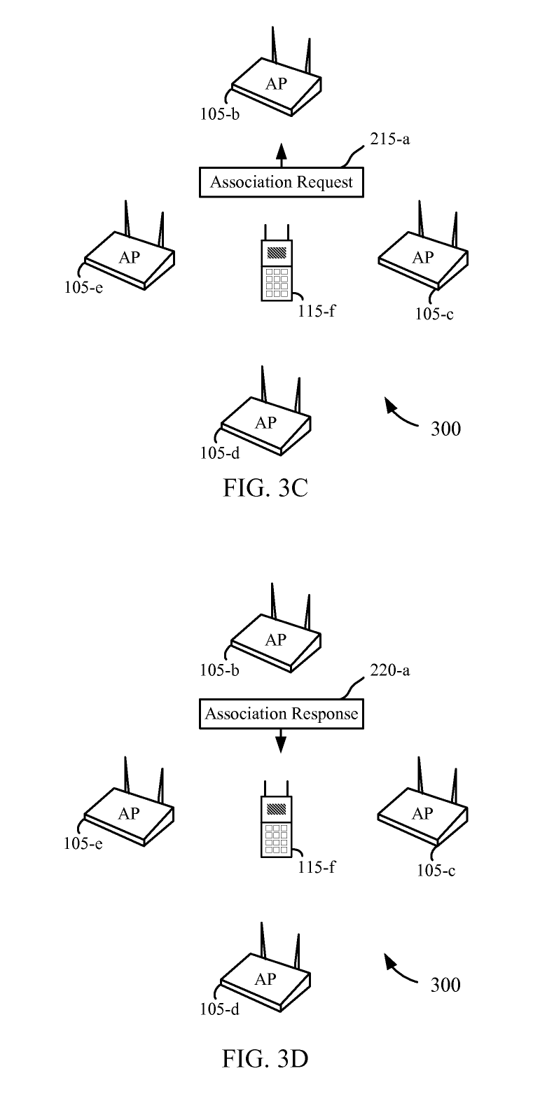

Referring next to FIGS. 3A, 3B, 3C, and 3D, an example is shown of access point discovery and association for a mobile device 115-f at a location associated with a set of access points 105. As shown in FIG. 3A, the mobile device 115-f may transmit a separate RTS frame 205 to each of the access points 105 in the identified set. In certain examples, the identified set of access points 105 may include each access point 105 known by the mobile device 115-f to be associated with the current location of the mobile device 115-f. Additionally or alternatively, the identified set of access points 105 may only include a certain number of preferred access points 105, and may exclude one or more non-preferred access points 105 known by the mobile device 115-f to be associated with the current location of the mobile device 115-f.

In certain examples, access points 105 of the identified set may be ranked in order of preference based on a number of criteria, and the RTS frames 205 may be sent to the access points 105 in the identified set in an order determined by the ranking. Examples of criteria that may be used to rank the access points 105 may include, but are not limited to, proximity of one or more access points 105 to the mobile device 115-f, predicted signal strength of one or more access points 105, predicted signal reception of one or more access points, predicted speed of wireless data transmission for one or more access points 105, previous experience with one or more access points 105, strength of security or encryption (e.g., WPA2 encryption vs. WEP encryption) for one or more access points 105, predicted or known coverage area of one or more access points 105, core network preferences (e.g. network provider, security, speed, etc.), and/or one or more user preferences.

Additionally or alternatively, a rules engine may apply a set of weighted rules to a set of parameters (including the ranking criteria listed above) associated with the access points 105 in the identified set and rank the access points 105 based on the outcome of the rules. In certain examples, the access points 105 may be ranked in an order of consecutive preference or priority (e.g., first, second, third, etc.). In other examples, the access points 105 may be categorized into a number of groups (e.g., more preferred, less preferred, etc.).

As shown in FIG. 3B, the mobile device 115-f may determine which of the access points 105 in the identified set is within range of the mobile device 115-f based on whether a CTS frame 210 is received from each access point 105. In the present example, the mobile device 115-f receives CTS frames 210 from access point 105-b, 105-c, and 105-d. No CTS frame is received from access point 105-e. Thus, even though each of the access points 105 may be associated with the location of the mobile device 115-f, the mobile device 115-f may determine that only access points 105-b, 105-c, and 105-d are within range. These in-range access points 105-b, 105-c, and 105-d may be candidates for association.

As shown in FIG. 3C, the mobile device 115-f may select one of the in-range access points 105 for association. In the present example, access point 105-b is selected for association, and the mobile device 115-f transmits an association request frame 215-a to access point 105-b. As described above, the association request frame 215-a may be transmitted to access point 105-b within a time period specified by or otherwise associated with the CTS frame 210-a.

Access point 105-b may be selected for association based on a ranking of the in-range access points 105 in terms of association preference. In certain examples, this ranking may be substantially the same as the ranking described above with respect to the order in which RTS frames are sent by mobile device 115-f. However, additional factors may influence how the access points 105 are ordered in terms of association preference. These additional factors may include parameters associated with the CTS frames 210 received by the mobile device 115-f. For example, an access point 105 that does not respond to the transmitted RTS frame with a CTS frame may be undesirable for association. Additionally or alternatively, an access point 105 for which the CTS frame was received with a high signal-to-noise ratio may rank higher in preference for association by the mobile device 115-f.

As shown in FIG. 3D, the mobile device 115-f may receive an association response frame 220-a from access point 105-b. The association response frame 220-a may indicate whether the mobile device 115-f has been successfully associated with access point 105-b. If the mobile device 115-f successfully associates with access point 105-b, the mobile device 115-f may end further discovery and association. Alternatively, the mobile device 115-f may attempt to associate with a next preferred access point 105 in parallel. Also, if the mobile device 115-f is not successful in associating with access point 105-b, the mobile device 115-f may attempt to associate with the next preferred access point 105.

While FIGS. 2 and 3A-3D illustrate discovery and association of access points 105 using the RTS/CTS methods of the present disclosure, it should be understood that in certain examples it may be desirable to use conventional methods of access point 105 discovery (e.g., probe or beacon discovery) in one set of circumstances and access point 105 discovery using RTS/CTS in another set of circumstances. In light of these considerations, it should be understood that the mobile devices 115 of the present disclosure may be configured to dynamically change methods of access point 105 discovery in real-time based on a detected set of operating conditions. In certain embodiments, a rules engine may apply a set of rules to a set of parameters to determine which method of access point 105 discovery, if any, to use.

Thus, a mobile device 115 may determine (e.g., using a rules engine) that a condition for enabling or disabling RTS/CTS discovery has been met, and dynamically enable or disable the use of received CTS frames by the mobile device for determining whether access points are in the range of the mobile device. Similarly, a mobile device 115 (e.g., using a rules engine) that a condition for enabling or disabling probe or beacon discovery has been met, and dynamically enable or disable access point discovery using probe or beacon scanning. In certain embodiments, a condition for enabling RTS/CTS discovery may be a condition for disabling probe or beacon discovery, and a condition for enabling probe or beacon discovery may be a condition for disabling RTS/CTS discovery.

For example, if a mobile device 115 determines that no known access points 105 are associated with its current location, or if the mobile device 115 does not have sufficient authentication credentials for known access point 105 associated with its current location, the mobile device 115 may dynamically disable RTS/CTS discovery and enable a probe or beacon form of access point discovery. Alternatively, there may be so many known access points 105 associated with the location of the mobile device 115 that using RTS/CTS discovery with each of the known access points 105 would be less cost-effective than using a probe or beacon form of access point discovery. In these examples, RTS/CTS discovery may be disabled and probe or beacon access point 105 discovery may be enabled.

In other examples, a mobile device 115 may only enable RTS/CTS discovery if a preferred access point is known to be associated with the current location of the mobile device 115. Otherwise, the mobile device 115 may enable a probe or beacon form of access point discovery. In still other examples, if RTS/CTS discovery is unsuccessful, the mobile device 115 may switch to a probe or beacon form of access point discovery.

In yet other examples, the form of access point discovery used by the mobile device 115 may be based on a set of user preferences, such as changes manually made by a user in real time and/or discovery profiles created by the user (e.g., turn on RTS/CTS when location is near the library or home, use probe discovery everywhere else).

In yet other examples, it may be determined that one or more unknown access points 105 may be within range of the mobile device 115 and that the one or more unknown access points 105 may possibly be more preferable than one or more access points 105 known to be associated with the current location of the mobile device 115. In these examples, the mobile device 115 may dynamically RTS/CTS discovery in favor of probe or beacon discovery.

In further examples, the determined location of one or more known access points 105 with respect to the current location of the mobile device 115 may influence the type of access point discovery used. For instance, if the mobile device 115 determines that the only access points 105 known to be associated with the current location of the mobile device 115 are at locations that are greater than a threshold distance away from the current location of the mobile device 115, the mobile device 115 may dynamically disable RTS/CTS discovery and enable probe or beacon discovery. Conversely, if the mobile device 115 determines that known access points 105 are near to the mobile device 115, the mobile device 115 may disable probe or beacon discovery and enable RTS/CTS discovery for the known access points 105.

In still other examples, one or more parameters related to the state of mobile device 115 may factor into the type of access point 105 discovery used. For example, if a battery for the mobile device 115 is low on power, the mobile device 115 may choose to use enable RTS/CTS discovery.

In addition to the above described dynamic selection of access point 105 discovery methods for different sets of conditions, the mobile device 115 of FIG. 1, 2, or 3 may also be configured to perform similar analysis to dynamically enable multiple types of concurrent access point 105 discovery and/or disable all types of access point 105 discovery.

The mobile device 115 of FIG. 1, 2, or 3 may further be configured to selectively enable or disable WLAN connectivity in real-time based on a set of current operating conditions. For example, the mobile device 115 may automatically enable WLAN connectivity in response to determining that the location of one or more known access points 105 is near to or otherwise associated with the location of the mobile device 115. The mobile device 115 may then use RTS/CTS discovery to determine whether the one or more known access points 105 are within range of the mobile device 115. In certain examples, the mobile device 115 may only automatically enable WLAN connectivity if a preferred access point 105 is known to be associated with the current location of the mobile device 115.

Additionally or alternatively, the mobile device 115 may dynamically enable or disable WLAN connectivity in response to one or more user preferences (e.g., manual changes, stored location profiles, etc.), one or more mobile device 115 conditions (e.g., disable WLAN if battery is low and the mobile device 115 is not associated with an access point), and/or any other parameter that may suit a particular implementation of these principles.

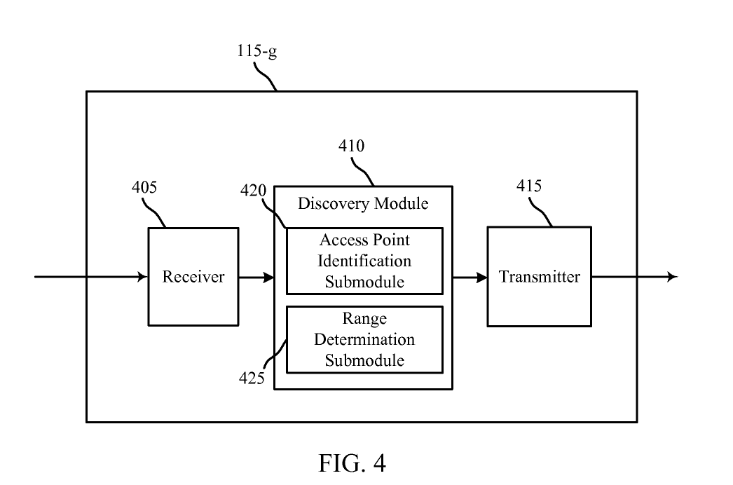

Referring next to FIG. 4, a block diagram is given of a mobile device 115-g configured for wireless communication. The mobile device 115-g may be an example of the mobile devices 115 described above with reference to FIG. 1, 2, or 3A-3D. The mobile device 115-g may include a receiver module 405, a discovery module 410, and a transmitter module 415. Each of these components may be in communication, directly or indirectly.

The discovery module 410 may include at least an access point identification submodule 420 and a range determination submodule 425. The access point identification submodule 420 may identify one or more WLAN access points (e.g., access point 105 of FIG. 1, 2, or 3A-3D) associated with a current location of the mobile device 115-g. The location of the mobile device 115-g may be determined in a number of ways, including Global Positioning Service (GPS) location, one or more cell identifications (cell-IDs) from a cellular network in communication with the mobile device 115-g, and/or any other suitable method of location determination.

The access point identification submodule 420 may identify the one or more WLAN access points 105 associated with the current location by accessing a table associating location information with access point 105 identifiers (e.g., MAC addresses, SSIDs, and/or BSSIDs). The table may include information generated and stored by the mobile device 115-g, information received from one or more third parties, and/or information received over a separate network connection (e.g., a cellular network connection). For example, a cellular or other network may provide the mobile device 115-g with a list of available access points 105 based on the location of the mobile device 115-g.

The range determination submodule 425 may determine whether one or more of the identified access points 105 is in range of the mobile device 115-g using RTS/CTS protocol. For example, the range determination submodule 425 may cause the transmitter module 415 to transmit an RTS frame to one or more of the identified access points 105. In certain examples, the range determination submodule 425 of the discovery module 410 may be configured to automatically cause the transmitter to transmit the RTS frame in response to a determination of the location of the mobile device and a determination that the one or more identified access points 105 are within range of the mobile device 115-g. The range determination submodule 425 may further communicate with the receiver module 405 to determine whether a CTS frame has been received from any of the access points 105 to which an RTS was sent. For each CTS frame received at the receiver module 405, the range determination submodule 425 may determine that the access point transmitting the CTS frame is within range of the access point 105.

If a single access point 105 is found to be within range of the mobile device 115-g, the mobile device 115-g may attempt to associate with that access point 105. If more than one access point 105 is found to be within range of the mobile device 115-g, the mobile device may attempt to associate with the access points, in an order of priority, until an association with one of the access points is established. If no access points 105 are found to be within range of the mobile device 115-g, the mobile device 115-g may switch to a different mode of access point 105 discovery or turn off WLAN connectivity.

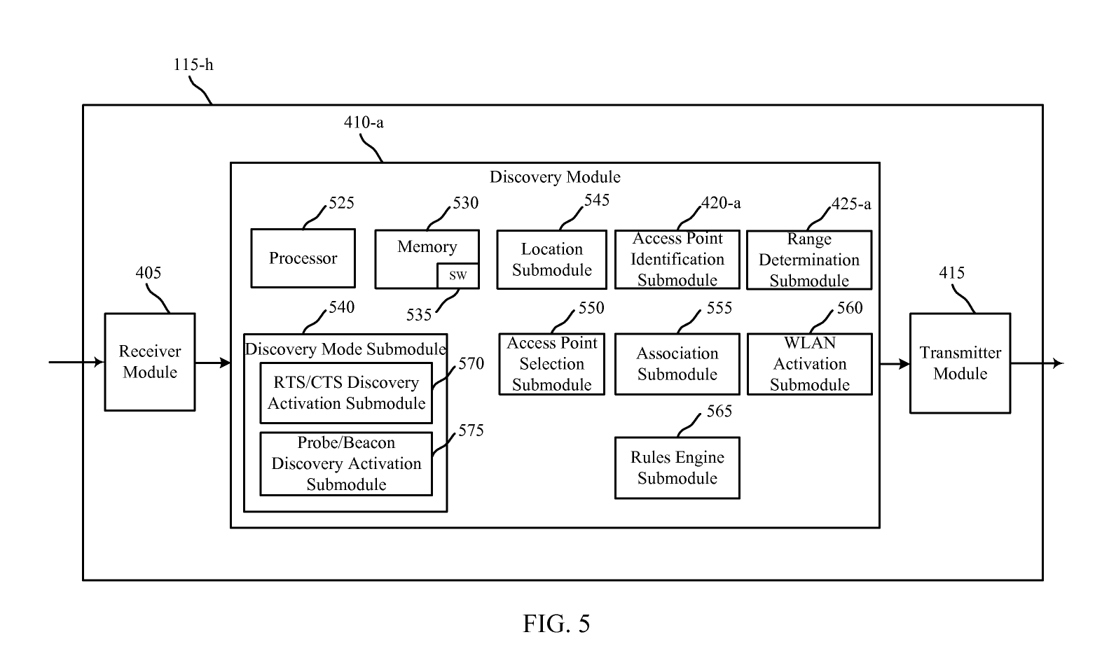

Referring next to FIG. 5, a block diagram is given of a more detailed example of a mobile device 115-h configured for wireless communications. The mobile device 115-h may be an example of the mobile device 115 described above with reference to FIG. 1, 2, 3A-D, or 4. The mobile device 115-h of the present example includes a receiver module 405, a discovery module 410-a, and a transmitter module 415. Each of these components may be in communication, directly or indirectly. The receiver module 405, discovery module 410-a, and transmitter module 415 may be examples of the receiver module 405, discovery module 410, and transmitter module 415 described above with reference to FIG. 4.

The discovery module 410-a of the present example may include one or more processors 525 and memory 530 communicatively coupled to the processor(s) 525. The memory 530 may store software 535 that is executed by the processor 525 to implement certain functionality. For example, the software 535 may include software 535 for implementing the functionality of one or more of the submodules 540, 420-a, 425-a, 545, 550, 555, 560, 565 shown in the discovery module 410-a of FIG. 5. These submodules include a discovery mode submodule 540, a location submodule 545, an access point identification submodule 420-a, a range determination submodule 425-a, an access point selection submodule 550, an association submodule 555, a WLAN activation submodule 560, and a rules engine submodule 565.

The discovery mode submodule 540 may include an RTS/CTS discovery activation submodule 570 and a probe/beacon discovery activation submodule 575. The RTS/CTS discovery activation submodule 570 may dynamically enable or disable discovery of WLAN access points (e.g., access point 105 of FIG. 1, 2, or 3A-3D) through the exchange of RTS/CTS frames, as described above with reference to FIGS. 2-4. The probe/beacon discovery activation module 575 may be configured to dynamically enable or disable discovery of WLAN access points 105 using conventional probe and/or beacon techniques. In certain examples, the discovery mode submodule 540 may be configured to enable both RTS/CTS discovery and probe or beacon discovery concurrently, enable only one of RTS/CTS discovery, probe discovery, or beacon discovery, or disable all forms of access point 105 discovery.

As previously mentioned, a number of factors may affect the decision to dynamically enable or disable RTS/CTS discovery and/or probe/beacon discovery. These factors may include, but are not limited to, the number of known access points 105 associated with a current location of the mobile device 115-h, the number of preferred access points associated with the current location of the mobile device 115-h, one or more user preferences, the distance of known access points 105 from the current location of the mobile device 115-h, one or more parameters related to the state of the mobile device 115-h, and/or any other factor that may suit a particular implementation of the principles of this disclosure.

The location submodule 545 may determine a current location of the mobile device 115-h. The location may be determined using, for example, a GPS receiver, data received from a network (e.g., the identity of one or more local cells of a cellular network), and/or any other suitable method of location. The current location of the mobile device 115-h determined by the location submodule 545 may be provided to the discovery module 540 for use in determining whether to dynamically enable or disable RTS/CTS access point discovery or probe/beacon access point discovery.

The access point identification submodule 420-a may be an example of the access point identification module 420 described above with reference to FIG. 4. The access point identification submodule 420-a may identify one or more access points 105 that are associated with the current location of the mobile device 115-h, as determined by the location submodule 545. Data used to identify the one or more access points associated with the current location of the mobile device 115-h may be stored locally by the mobile device 115-h (e.g., in memory 530) and/or dynamically received over a network connection (e.g., from another access point or a cellular base station). A list or table of the identified access points 105 may be provided, for example, to the discovery mode submodule 540 for use in dynamically determining an appropriate mode of access point discovery.

The range determination submodule 425-a may be an example of the range determination module 425 described above with reference to FIG. 4. When RTS/CTS discovery is activated by the discovery mode submodule 540, the range determination submodule 425-a may cause the transmitter module 415 to transmit an RTS frame to one or more of the access points 105 identified by the access point identification submodule 420-a. For each of the identified access points 105 to which an RTS frame is sent, the range determination module 425-a may determine whether a CTS frame has been received at receiver module 405 during a designated response time from that access point 105.

If a CTS frame has been received from an access point 105 during the designated response time, the range determination submodule 425-a may determine that the access point 105 to be within range of the mobile device 115-h. Similarly, if no CTS frame is received from the access point 105 during the designated response time, the range determination submodule 425-a may determine that the access point 105 is not within range of the mobile device 115-h.

The access point selection submodule 550 may select, from the access point(s) 105 that the range determination submodule 425-a determines to be within range of the mobile device 115-h, one or more access points 105 for WLAN association. In certain examples, only one access point 105 may be within range of the mobile device 115-h, and that access point 105 may be automatically selected by the access point selection submodule 550.

In the event that multiple candidate access points 105 are within range of the mobile device 115-h, various criteria may be used by the access point selection submodule 550 to select an access point 105 for association. As described above, these criteria may include, but are limited to, proximity of the candidate access points 105 to the mobile device 115-h, measured signal strength of the received CTS frames, actual or predicted signal reception at the access points 105, actual or predicted speed of wireless data transmission for the access points, previous experience with one or more of the access points 105, strength of security or encryption type of one or more of the access points 105, size or shape of the coverage area for one or more of the access points 105, the identity of a core network associated with one or more of the access points 105, and/or any other applicable criteria. In certain examples, the access point selection submodule 550 may establish an order of selection preference or priority for the access points 105 determined to be within range of the mobile device 115-h.

In certain examples, the access point selection submodule 550 may also be configured to select one or more access points 105 for association from a number of access points 105 discovered using probe or beacon discovery. The access point selection submodule 550 may apply substantially the same selection criteria described above with respect to RTS/CTS discovery in selecting one or more access points 105 identified using probe or beacon discovery.

The association submodule 555 may be configured to establish WLAN association with the one or more access points 105 selected by the access point selection submodule 550. The association submodule 555 may establish the WLAN association by generating an association request frame in response to the received CTS frame and causing the transmitter module 415 to transmit the association request frame to the one or more access points 105 selected by the access point selection submodule 550. The association submodule 555 may control the transmitter module 415 to transmit the association request frame to the access point in a time period associated with the CTS frame. In certain examples, the time period associated with the CTS frame may include a duration field of the CTS frame.

The association submodule 555 may monitor the receiver module 405 to receive an association response frame from each of the one or more selected access points 105. The association response frame(s) may indicate that a WLAN association has been established with the one or more selected access points 105. Otherwise, the association submodule 555 may attempt to associate with one or more identified access points 105 that are next in line with regard to priority or preference.

The WLAN activation submodule 560 may dynamically enable and disable WLAN connectivity in the mobile device 115-h based on one or more current conditions. For example, the WLAN activation submodule 560 may dynamically enable WLAN connectivity in response to the access point identification submodule 420-a determining that one or more known access points 105 are associated with a current location of the mobile device 115-h, as determined by the location submodule 545.

Additionally or alternatively, the WLAN activation submodule 560 may dynamically enable or disable WLAN connectivity in the mobile device based on whether one or more known access points 105 associated with the current location of the mobile device 115-h are preferred, one or more user preferences (e.g., a user manually enabling or disabling WLAN connectivity, a location profile generated by a user to automatically enable or disable WLAN connectivity in certain locations, etc.), one or more mobile device 115-h conditions (e.g., battery strength, whether the mobile device 115-h is currently associated with an access point 105), and/or any other parameter that may suit a particular implementation of these principles.

The rules engine submodule 565 may be configured to make logical deductions based on a set of one or more rules stored by the mobile device 115-h. The rules engine submodule 565 may, for example, apply a set of rules to a number of parameters on behalf of the discovery mode submodule 540 to deduce whether to enable RTS/CTS access point 105 discovery, enable probe or beacon access point 105 discovery, enable all forms of access point 105 discovery, or disable all forms of access point 105 discovery. The rules engine submodule 565 may also, for example, apply a set of rules to a number of parameters on behalf of the access point selection submodule 550 to identify an order of association preference for a number of identified access points 105 and/or apply a set of rules to a number of parameters on behalf of the WLAN activation submodule 560 to determine whether to dynamically enable or disable WLAN connectivity in the mobile device 115-h.

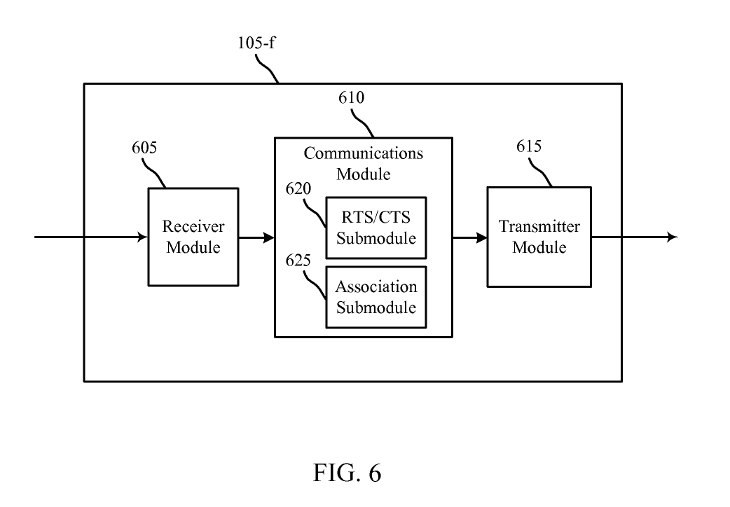

Referring next to FIG. 6, a block diagram is given of an example of a WLAN access point 105-f configured for wireless communications. The access point 105-f may be an example of the access point 105 described above with reference to FIG. 1, 2, or 3A-3D. The access point 105-f of the present example includes a receiver module 605, a communications module 610, and a transmitter module 615. Each of these components may be in communication, directly or indirectly.

The receiver module 605 may be configured to receive an RTS frame from a mobile device (e.g., mobile device 115 of FIG. 1, 2, 3A-3D, 4, or 5). The mobile device 115 may not be associated with the access point 105-f. That is, the mobile device 115 may not be registered with the access point 105-f or have access to a core network by way of the access point 105-f. The RTS frame may request clearance to transmit data to the access point 105-f for a null amount of time. Alternatively, the RTS frame may request clearance to transmit data to the access point 105-f for an amount of time that is greater than a threshold associated with receiving a response from the access point 105-f.

An RTS/CTS submodule 620 of the communications module 620 may process the received RTS frame and generate a CTS frame in response to the RTS frame. The communications module may cause the transmitter module 615 to transmit the generated CTS frame to the mobile device 115.

The CTS frame may specify or otherwise be associated with a period of time during which the mobile device 115 is cleared to transmit data to the access point 105-f. In certain examples, the period of time associated with the CTS frame may be the same as the period of time for which clearance to transmit was requested in the RTS frame. Alternatively, the period of time associated with the CTS frame may be different from the period of time requested with the RTS frame. For example, the access point 105-f may receive an RTS frame requesting clearance to transmit to the access point 105-f for a null amount of time. The access point 105-f may recognize this particular type of RTS frame as being associated with access point discovery by the mobile device 115, and generate a CTS frame to the mobile device 115 which specifies an amount of time chosen by the access point 105-f during which the mobile device 115 may send an association request frame to the access point 105-f and/or receive an association response frame from the access point 105-f.

The receiver module 605 may further be configured to receive an association request frame from the mobile device 115, the association request frame being sent in response to the CTS frame. The association request frame may be received by the receiver module 605 within the period of time specified by or otherwise associated with the transmitted CTS frame.

An association submodule 625 may process the association request frame and determine whether the mobile device 115 qualifies for association. If the mobile device 115 qualifies for association, the association submodule 625 may register the mobile device 115 and provide the mobile device 115 access to one or more core networks associated with the access point. The association submodule 625 may also generate an association response frame indicating whether the mobile device 115 has been associated with the access point 105-f. The communications module 610 may cause the transmitter module 615 to transmit the association response frame to the mobile device 115. In certain examples, the association response frame may be transmitted to the mobile device 115 within the time period specified by or otherwise associated with the earlier transmitted CTS frame.

In certain examples, the access point 105-f may be further configured to indirectly provide its location and identifier (e.g., MAC address, SSID, BSSID, etc.) to the mobile device 115 for the mobile device to use in access point discovery. For example, the access point 105-f may directly or indirectly communicate with a cellular network to provide its current location to one or more servers on the cellular network. When the mobile device 115 enters a location for which the access point 105-f may be in range, the cellular network may transmit a message to the mobile device 115 indicating that the access point 105-f is associated with a current location of the mobile device, and the mobile device 115 may initiate discovery of the access point 105-f using RTS/CTS frames as described above.

In additional or alternative examples, the access point 105-f may provide its current location to a server, which the mobile device 115 may access to obtain and store a table or list of one or more known access points associated with corresponding locations. When the mobile device 115 enters a location within range of the access point 105-f, the mobile device 115 may determine from the stored table that the access point 105-f is associated with the current location of the mobile device 115, and initiate discovery using RTS/CTS frames.

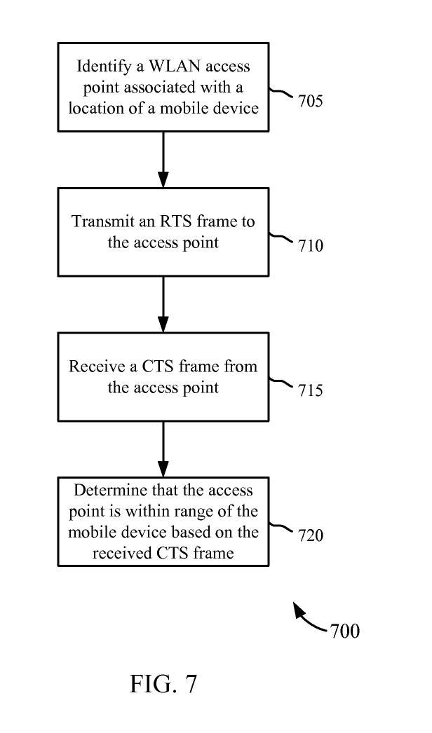

FIG. 7 illustrates an example of a method 700 of using RTS/CTS frames for WLAN discovery at a mobile device, according to the principles of the present disclosure. The method 700 may be performed, for example, by the mobile device 115 described above with reference to FIG. 1, 2, 3A-3D, 4, or 5. At block 705, a WLAN access point (e.g., access point 105 of FIG. 1, 2, 3A-3D, or 6) associated with a current location of the mobile device is identified. At block 710, a Request to Send (RTS) frame is transmitted to the access point. At block 715, a Clear to Send (CTS) frame is received from the access point. At block 720, it is determined that the access point is within range of the mobile device based on the received CTS frame.

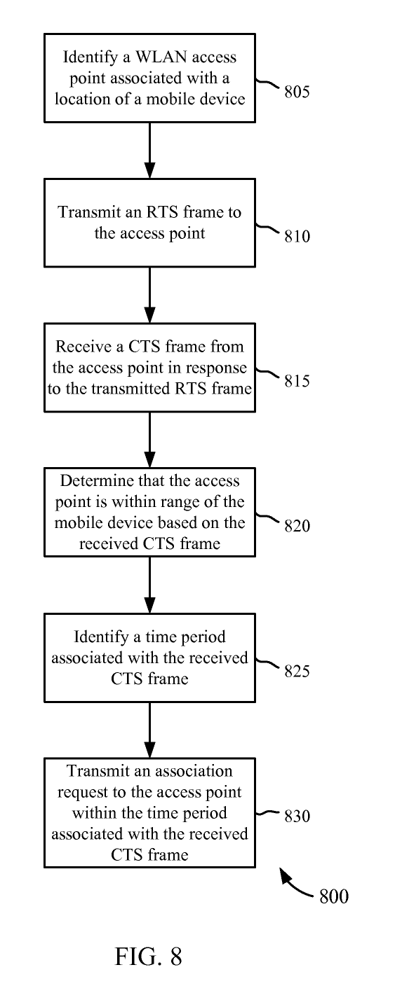

FIG. 8 illustrates another example of a method 800 of using RTS/CTS frames for WLAN discovery at a mobile device, according to the principles of the present disclosure. The method 800 may be performed, for example, by the mobile device 115 described above with reference to FIG. 1, 2, 3A-3D, 4, or 5. At block 805, a WLAN access point (e.g., access point 105 of FIG. 1, 2, 3A-3D, or 6) associated with a current location of the mobile device is identified. At block 810, an RTS frame is transmitted to the access point. At block 815, a CTS frame is received from the access point. At block 820, it is determined that the access point is within range of the mobile device based on the received CTS frame. At block 825, a time period associated with the received CTS frame is identified. In certain examples, the time period may be specified as a field of the CTS frame. At block 830, an association request is transmitted to the access point within the time period associated with the received CTS frame.

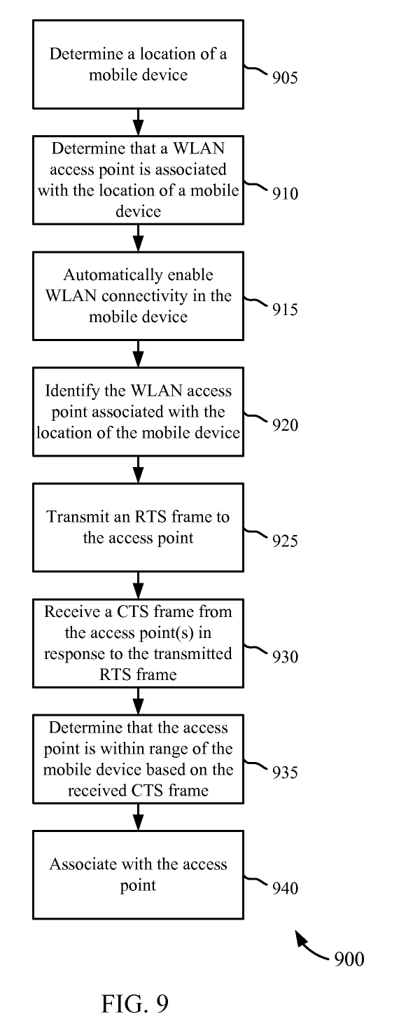

FIG. 9 illustrates another example of a method 900 of using RTS/CTS frames for WLAN discovery at a mobile device, according to the principles of the present disclosure. The method 900 may be performed, for example, by the mobile device 115 described above with reference to FIG. 1, 2, 3A-3D, 4, or 5. At block 905, a location of the mobile device is determined. At block 910, it is determined that a WLAN access point (e.g., access point 105 of FIG. 1, 2, 3A-3D, or 6) is associated with the location of the mobile device. At block 915, WLAN connectivity is automatically enabled in the mobile device. At block 920, the access point associated with the current location of the mobile device is identified. At block 925, an RTS frame is transmitted to the access point. At block 930, a CTS frame is received from the access point in response to the transmitted RTS frame. At block 935, it is determined that the access point is within range of the mobile device based on the received CTS frame. At block 940, the mobile device associates with the access point.

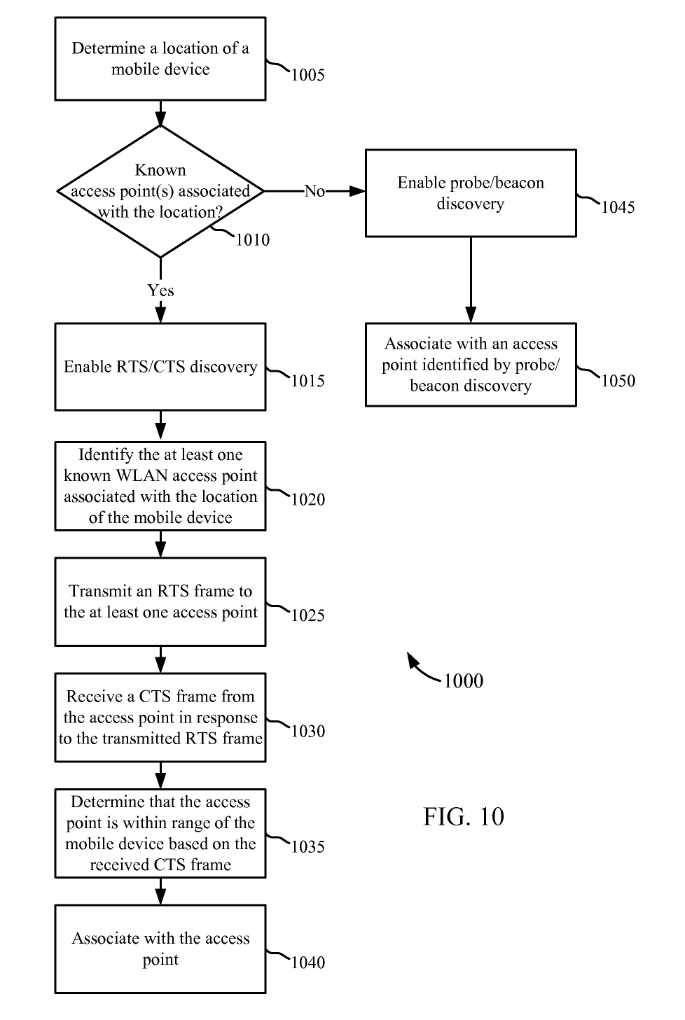

FIG. 10 illustrates another example of a method 1000 of using RTS/CTS frames for WLAN discovery at a mobile device, according to the principles of the present disclosure. The method 1000 may be performed, for example, by the mobile device 115 described above with reference to FIG. 1, 2, 3A-3D, 4, or 5. At block 1005, a current location of the mobile device is determined. At block 1010, a determination is made as to whether any known access point is associated with the current location of the mobile device. If no known access point is associated with the current location of the mobile device, probe or beacon discovery is enabled in the mobile device at block 1045. In certain examples, enabling probe or beacon discovery may also include disabling RTS/CTS discovery. At block 1050 the mobile device associates with an access point identified using probe or beacon discovery.

However, if it is determined at block 1010 that at least one known access point (e.g., access point 105 of FIG. 1, 2, 3A-3D, or 6) is associated with the current location of the mobile device, RTS/CTS discovery is enabled at block 1015. In certain examples, enabling RTS/CTS discovery may include disabling probe or beacon discovery. The known access point associated with the location of the mobile device is identified at block 1020. At block 1025, an RTS frame is transmitted to the access point. At block 1030, a CTS frame is received from the access point. At block 1035, it is determined that the access point is within range of the mobile device based on the received CTS frame. At block 1040, the mobile device associates with the access point.

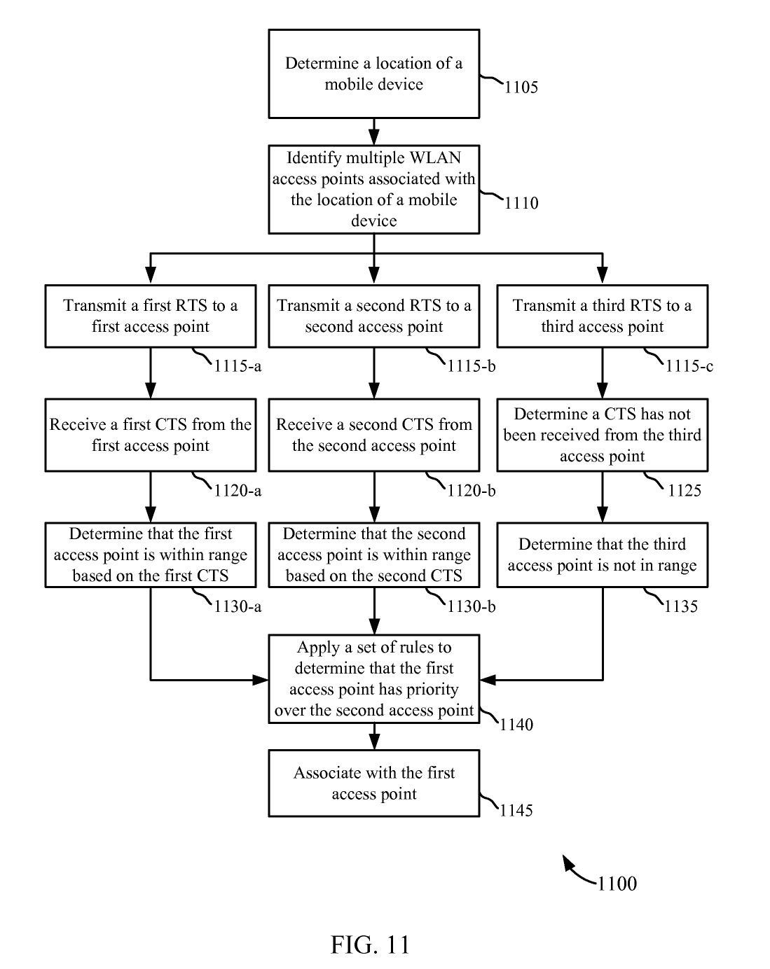

FIG. 11 illustrates another example of a method 1100 of using RTS/CTS frames for WLAN discovery at a mobile device, according to the principles of the present disclosure. The method 1100 may be performed, for example, by the mobile device 115 described above with reference to FIG. 1, 2, 3A-3D, 4, or 5. At block 1105, a location of the mobile device is determined. At block 1110, a set of multiple WLAN access points (e.g., access point 105 of FIG. 1, 2, 3A-3D, or 6) associated with the location of the mobile device 115 are identified.

At blocks 1115-a, 1115-b, and 1115-c, the mobile device transmits a first RTS, a second RTS, and a third RTS, respectively, to a first, second, and third of the identified access points. At blocks 1120-a and 1120-b, a first CTS is received from the first access point and a second CTS is received from the second access point. At block 1125 it is determined that a CTS response has not been received from the third access point. At blocks 1130-a and 1130-b, it is determined that the first and second access points are within range of the mobile device based on the first and second CTS frames, respectively. At block 1135, it is determined that the third access point is not in range based on the absence of a reply to the third RTS.

At block 1140, a set of rules is applied to determine that the first access point has priority over the second access point. At block 1145, the mobile device associates with the first access point.

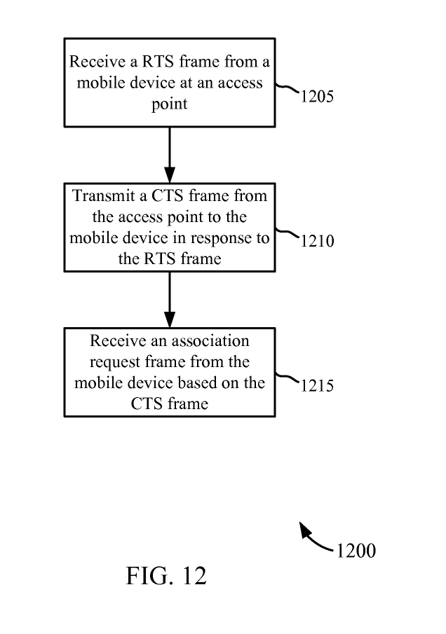

FIG. 12 illustrates an example of a method 1200 for WLAN association at an access point, according to the principles of the present disclosure. The method 1200 may be performed, for example, by the access point 105 described above with reference to FIGS. 1, 2, 3A-3D, and 6. At block 1205, an RTS frame is received from a mobile device (e.g., mobile device 115 of FIG. 1, 2, 3A-3D, 4, or 5) at the access point. The mobile device may not be associated with the access point. At block 1210, a CTS frame is transmitted from the access point to the mobile device in response to the RTS frame. At block 1215, an association request frame is received from the mobile device based on the CTS frame.

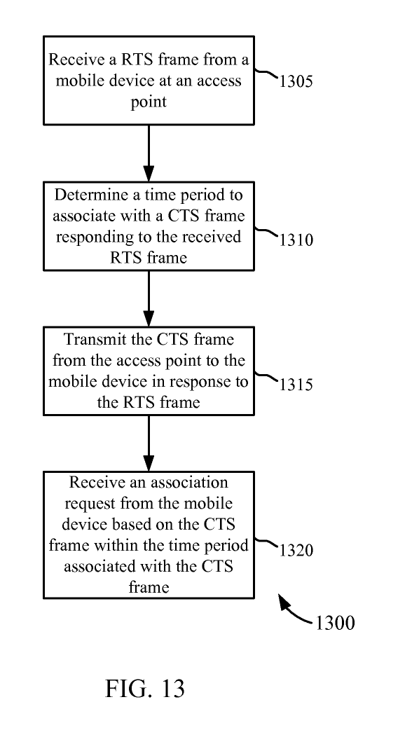

FIG. 13 illustrates another example of a method 1300 for WLAN association at an access point, according to the principles of the present disclosure. The method 1300 may be performed, for example, by the access point 105 described above with reference to FIGS. 1, 2, 3A-3D, and 6. At block 1305, an RTS frame is received from a mobile device (e.g., mobile device 115 of FIG. 1, 2, 3A-3D, 4, or 5) at the access point. The mobile device may not be associated with the access point. At block 1310, a time period is determined to associate with a CTS frame responding to the received RTS frame. At block 1315, the CTS frame is transmitted from the access point to the mobile device in response to the RTS frame. At block 1320, an association request frame is received from the mobile device based on the CTS frame and within the time period associated with the CTS frame.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communication in a mobile device, comprising:
identifying a wireless local area network (WLAN) access point associated with a location of the mobile device;
transmitting a Request to Send (RTS) frame to the access point;
receiving a Clear to Send (CTS) frame from the access point; and
determining that the access point is within range of the mobile device based on the received CTS frame.

2. The method of claim 1, further comprising:
transmitting an association request frame to the access point in response to the received CTS frame.

3. The method of claim 2, further comprising:
transmitting the association request frame to the access point in a time period associated with the CTS frame.

4. The method of claim 1, wherein the RTS frame comprises a request for clearance to transmit data for a null amount of time.

5. The method of claim 1, wherein the RTS frame comprises a request for clearance to transmit data for an amount of time that is greater than a threshold associated with receiving a response from the access point.

6. The method of claim 1, further comprising:
determining the location of the mobile device;
determining a set of one or more wireless access points, including the identified access point, associated with the location of the mobile device; and
automatically transmitting the RTS frame to the set of one or more wireless access points in response to the determining the location of the mobile device and the determining the set of one or more wireless access points.

7. The method of claim 1, further comprising:
determining the location of the mobile device; and
selectively enabling WLAN connectivity in the mobile device in response to the determining the location of the mobile device.

8. The method of claim 7, further comprising:
determining that the location of the mobile device is near a location of the access point; and
selectively enabling WLAN connectivity in the mobile device in response to the determining the location of the mobile device and the determining that the location of the mobile device is near the location of the access point.

9. The method of claim 1, further comprising:
determining that a condition for disabling RTS/CTS discovery has been met; and
disabling use of received CTS frames by the mobile device to determine whether access points are in the range of the mobile device.

10. The method of claim 9, wherein determining that the condition for disabling RTS/CTS discovery has been met comprises:
determining that no known access point is associated with the location of the mobile device.

11. The method of claim 9, further comprising:
selectively enabling at least one of probe discovery or beacon discovery in response to the determining that the condition for disabling RTS/CTS discovery has been met.

12. The method of claim 1, further comprising:
communicating with a cellular network to identify the access point associated with the location of the mobile device.

13. The method of claim 1, further comprising:
accessing a table of access points stored by the mobile device to identify the access point based on the location of the mobile device.

14. The method of claim 1, further comprising:
transmitting a plurality of RTS frames to a plurality of access points;
receiving a plurality of CTS frames in response to the RTS frames;
determining that a number of access points of the plurality of access points are in range of the mobile device based on the received CTS frames; and
selecting one of the access points in range of the mobile device for association with the mobile device.

15. The method of claim 14, further comprising:
selecting the one of the access points for association with the mobile device based on a set of rules.

16. The method of claim 14, further comprising:
selecting the one of the access points for association with the mobile device based on input from a user of the mobile device.

17. A mobile device configured for wireless communication, comprising:
an access point identification module configured to identify a wireless local area network (WLAN) access point associated with a location of the mobile device;
a transmitter module configured to transmit a Request to Send (RTS) frame to the access point;
a receiver module configured to receive a Clear to Send (CTS) frame from the access point; and
a range determination module configured to determine that the access point is within range of the mobile device based on the received CTS frame.

18. The mobile device of claim 17, further comprising:
an association module configured to generate an association request frame for the access point in response to the received CTS frame;
wherein the transmitter module is further configured to transmit the association request frame to the access point.

19. The mobile device of claim 18, wherein the association module is further configured to:
control the transmitter module to transmit the association request frame to the access point in a time period associated with the CTS frame.

20. The mobile device of claim 17, further comprising:
a location module configured to determine the location of the mobile device;
the access point identification module further configured to determine a set of one or more wireless access points, including the identified access point, associated with the location of the mobile device; and
a discovery module configured to configured to automatically cause the transmitter module to transmit the RTS frame to the access point in response to the determining the location of the mobile device and the determining the set of one or more wireless access points.

21. An apparatus configured to connect to a wireless local area network (WLAN), comprising:
means for identifying a WLAN access point associated with a location of the mobile device;
means for transmitting a Request to Send (RTS) frame to the access point;
means for receiving a Clear to Send (CTS) frame from the access point; and
means for determining that the access point is within range of the mobile device based on the received CTS frame.

22. The apparatus of claim 21, further comprising:
means for transmitting an association request frame to the access point in response to the received CTS frame.

23. The apparatus of claim 22, further comprising:
means for transmitting the association request frame to the access point in a time period associated with the CTS frame.

24. The apparatus of claim 21, wherein the RTS frame comprises a request for clearance to transmit data to the access point for a null amount of time.

25. The apparatus of claim 21, wherein the RTS frame comprises a request for clearance to transmit data to the access point for an amount of time that is greater than a threshold associated with receiving a response from the access point.

26. The apparatus of claim 21, further comprising:
means for determining the location of the mobile device;
means for determining a set of one or more wireless access points, including the identified access point, associated with the location of the mobile device; and
means for automatically transmitting the RTS frame to the set of one or more access points in response to the determining the location of the mobile device and the determining the set of one or more wireless access points.

27. The apparatus of claim 21, further comprising:
means for determining the location of the mobile device; and
means for selectively enabling WLAN connectivity in the mobile device in response to determining the location of the mobile device.

28. The apparatus of claim 27, further comprising:
means for determining that the location of the mobile device is near a location of the access point; and
means for selectively enabling WLAN connectivity in the mobile device in response to the determining the location of the mobile device and the determining that the location of the mobile device is near the location of the access point.

29. The apparatus of claim 21, further comprising:
means for determining a condition for disabling RTS/CTS discovery has been met; and
means for disabling determination by the mobile device of whether access points are in the range of the mobile device based on received CTS frames.

30. The apparatus of claim 29, wherein the means for determining that the condition for disabling RTS/CTS discovery has been met comprises:
means for determining that no known access point is associated with the location of the mobile device.

31. The apparatus of claim 29, further comprising:
means for selectively enabling at least one of probe discovery or beacon discovery in response to determining that the condition for disabling RTS/CTS discovery has been met.

32. The apparatus of claim 21, further comprising:
means for communicating with a cellular network to identify the access point associated with the location of the mobile device.

33. The apparatus of claim 21, further comprising:
means for transmitting a plurality of RTS frames to a plurality of access points;
means for receiving a plurality of CTS frames in response to the RTS frames;
means for determining that a number of access points of the plurality of access points are in range of the mobile device based on the received CTS frames; and
means for selecting one of the access points in range of the mobile device for association with the mobile device.

34. The apparatus of claim 33, further comprising:
means for selecting the one of the access points for association with the mobile device based on a set of rules.

35. A computer program product configured to connect to a wireless local area network (WLAN), the product comprising a non-transitory computer-readable medium, the medium comprising:
code to identify a WLAN access point associated with a location of the mobile device;
code to transmit a Request to Send (RTS) frame to the access point;
code to receive a Clear to Send (CTS) frame from the access point; and
code to determine that the access point is within range of the mobile device based on the received CTS frame.

36. A method for wireless communication in a wireless local area network (WLAN) access point, comprising:
receiving a Request to Send (RTS) frame at an access point from a mobile device;
transmitting a Clear to Send (CTS) frame from the access point to the mobile device in response to the RTS frame; and
receiving an association request frame from the mobile device based on the CTS frame.

37. The method of claim 36, further comprising:
receiving the association request frame from the mobile device within a time period associated with the CTS frame.

38. The method of claim 37, wherein the time period associated with the CTS frame comprises a time period for transmission specified by the CTS frame.

39. The method of claim 37, further comprising:
transmitting an association response frame to the mobile device within the time period associated with the CTS frame.

40. The method of claim 36, wherein the RTS frame comprises a request for clearance to transmit data to the access point for a null amount of time.

41. The method of claim 36, wherein the RTS frame comprises a request for clearance to transmit data to the access point for an amount of time that is greater than a threshold associated with receiving a response from the access point.

42. The method of claim 36, further comprising:
providing a location of the access point to the mobile device.

43. The method of claim 42, further comprising:
communicating with a cellular network to provide the location of the access point to the mobile device.

44. A wireless local area network (WLAN) access point apparatus, comprising:
means for receiving a Request to Send (RTS) frame at an access point from a mobile device;
means for transmitting a Clear to Send (CTS) frame from the access point to the mobile device in response to the RTS frame; and
means for receiving an association request frame from the mobile device based on the CTS frame.

45. The apparatus of claim 44, further comprising:
means for receiving the association request frame from the mobile device within a time period associated with the CTS frame.

46. The apparatus of claim 45, wherein the time period associated with the CTS frame comprises a time period for transmission specified by the CTS frame.

47. The apparatus of claim 45, further comprising:
means for transmitting an association acknowledgment message to the mobile device within the time period associated with the CTS frame.
